(19) United States
(12) Patent Application Publication
(10) Pub. No.: US 2026/0007972 A1
(43) Pub. Date: Jan. 8, 2026

(54) SYSTEM FOR MANAGING VIRTUAL RESOURCE PRODUCTION BY VIRTUAL CHARACTERS IN AN ELECTRONIC GAME

(71) Applicant: Microsoft Technology Licensing, LLC, Redmond, WA (US)

(72) Inventors: Alex Yu LIU, Portland, OR (US); Kristen Marie HANLON PIRILLO, Carnation, WA (US)

(21) Appl. No.: 18/761,992

(22) Filed: Jul. 2, 2024

(51) Int. Cl. A63F 13/56; A63F 13/67; A63F 13/822; G06N 5/022

(52) U.S. Cl. CPC A63F 13/56; A63F 13/67; A63F 13/822; G06N 5/022

(57) ABSTRACT

A method for automating digital resource production within a real-time strategy game. The method includes identifying a virtual character at a first location in a virtual space, the virtual character capable of gathering virtual resources, and identifying a set of resource-gathering factors for the virtual character. Based on these factors, the method expands a defined distance from a second location in the virtual space within which the virtual character operates to include a third location in the virtual space, determines a virtual resource-gathering assignment, and instructs the virtual character to traverse to the third location. The set of resource-gathering factors includes a virtual resource production goal, a reserve of a virtual resource, an availability of a source of the virtual resource, a likelihood of an additional virtual resource source at the third location, and a likely peril to the virtual character in traversing to the third location.

### BACKGROUND

Real-time strategy (RTS) games have been a popular genre of video games for decades. These games often involve managing virtual resources, building virtual structures, and commanding virtual characters (units) to achieve a strategic objective. The gameplay can be complex, requiring users (players) to make quick decisions and execute precise actions. A cornerstone of RTS games is gathering virtual resources, which may be analogs to real-world resources (e.g., food, wood, stone, gold, silver) or may even be mystical resources (e.g., favor, mana, essence, faith, wisdom). To gather these virtual resources, the user needs to manage individual virtual characters (e.g., villagers, peasants, drones, workers) that operate as economic development units that can interact with different types of virtual resource sources (e.g., farms, animals, bodies of water, forests, mines, temples, shrines). The user may need to balance the allocation of virtual characters to different virtual resource sources, considering factors such as the distance, availability, and risk of each source.

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to methods, systems, and computer program products implemented by a real-time strategy game, including: identifying a virtual character residing at a first location in a virtual space that is within a defined distance from a second location in the virtual space, the virtual character capable of gathering a plurality of virtual resource types based on interfacing with virtual resource sources of a plurality of different types, each type of virtual resource source enabling the virtual character to produce a different type of virtual resource; identifying a set of resource-gathering factors for the virtual character, the set of resource-gathering factors including at least: a virtual resource production goal, the virtual resource production goal specifying a relative allocation of each of the plurality of virtual resource types to be gathered by a set of virtual characters that includes the virtual character, the virtual resource production goal including a goal to gather an amount of a particular virtual resource type; a reserve of the particular virtual resource type that has been previously gathered by the set of virtual characters; an availability of a virtual resource source that provides the particular virtual resource type within the defined distance from the second location in the virtual space; a likelihood of an additional virtual resource source that provides the particular virtual resource type existing at a third location in the virtual space, the third location in the virtual space being beyond the defined distance from the second location in the virtual space; and a likelihood of peril to the virtual character existing between the first location in the virtual space and the third location in the virtual space; and based on the set of resource-gathering factors: expanding the defined distance to include the third location in the virtual space; determining a virtual resource-gathering assignment for the virtual character that includes traversing from the first location in the virtual space to the third location in the virtual space; and instructing the virtual character to traverse from the first location in the virtual space to the third location in the virtual space.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a computer architecture that facilitates automating digital resource production within a real-time strategy (RTS) game;

FIG. 2 illustrates an example of a virtual resource automation component;

FIGS. 3A and 3B illustrate an example of the operation of the resource automation component during an RTS game session;

FIG. 4 illustrates a flow chart of an example of a method for automating digital resource production within an RTS game; and

FIG. 5 illustrates an example user interface that allows a player to set a resource production goal.

### DETAILED DESCRIPTION

One of the challenges in designing real-time strategy (RTS) games is creating an intuitive and efficient control scheme. For example, RTS games generally include virtual characters (units) that operate as economic development units. Efficiently controlling economic development units to gather virtual resources in RTS games can be challenging. Users (players) must constantly monitor economic development units, assign them tasks, and make sure they are not being harmed by enemies, wild animals, etc. On a personal computer (PC), players use a mouse and keyboard to quickly and precisely control their virtual characters. However, managing many economic development units and ensuring they efficiently gather virtual resources can be difficult even with a mouse and keyboard. The challenge becomes even greater when designing an RTS game for a console. Mapping the control scheme from a PC (mouse and keyboard) to a console (controller input) can be difficult, as controllers have fewer buttons and less precision than a mouse and keyboard. This can make it harder for players to quickly select and assign tasks to their virtual characters, including economic development units, resulting in a less efficient resource-gathering process than on a PC.

The embodiments described herein are directed to methods and systems for managing virtual resource gathering by virtual characters in an RTS—such as AGE OF EMPIRES, AGE OF MYTHOLOGY, and the like. These embodiments allow a player to set a resource production goal for the entire society of economic development units rather than individually controlling each unit. These embodiments then automatically assign virtual characters tasks to collect resources according to the resource production goal and adjust the assignments based on various factors, such as the availability and location of virtual resource sources, the presence and proximity of enemies, the specific characteristics and bonuses of each unit type and civilization, and the like. Some embodiments also allow a player to create, save, and share custom resource production goal presets. Some embodiments also allow a player to use site-based commands to direct virtual characters to a desired destination or action quickly. The embodiments described herein reduce the number of individual user interface (UI) interactions and the cognitive load for the player and make RTS games more accessible and enjoyable on console platforms, such as XBOX from MICROSOFT, PLAYSTATION from SONY, and SWITCH from NINTENDO.

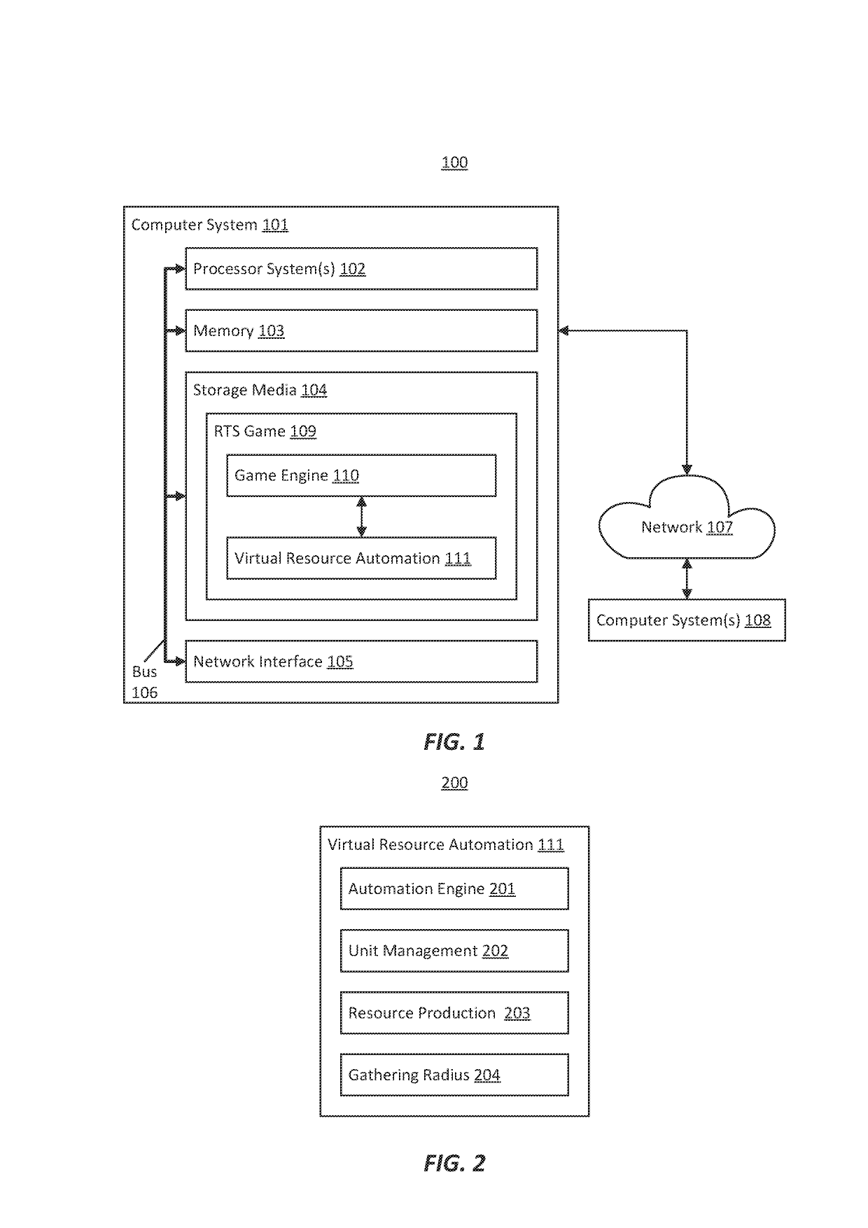

FIG. 1 illustrates an example of a computer architecture 100 that facilitates automating digital resource production within an RTS. As shown, the computer architecture 100 includes a computer system 101 comprising a processor system 102 (e.g., a single processor or a plurality of processors), a memory 103 (e.g., system or main memory), and a storage medium 104 (e.g., a single computer-readable storage medium, or a plurality of computer-readable storage media), all interconnected by a bus 106. As shown, computer system 101 may also include other hardware, such as a network interface 105 (e.g., one or more network interface cards) for interconnecting (via a network 107) to a remote computer system 108 (e.g., a single computer system or a plurality of computer systems).

FIG. 1 illustrates the storage medium 104 as storing computer-executable instructions implementing an RTS game 109, including at least a game engine 110 that manages the overall execution of RTS game 109 and a virtual resource automation component 111 (resource automation component 111). In embodiments, virtual resource automation component 111 works with game engine 110 to automate virtual resource gathering by virtual characters, e.g., economic development units presented as digital representations of villagers, peasants, drones, workers, and the like. Although resource automation component 111 is illustrated as separate from the game engine 110, in some embodiments, resource automation component 111 is part of the game engine 110.

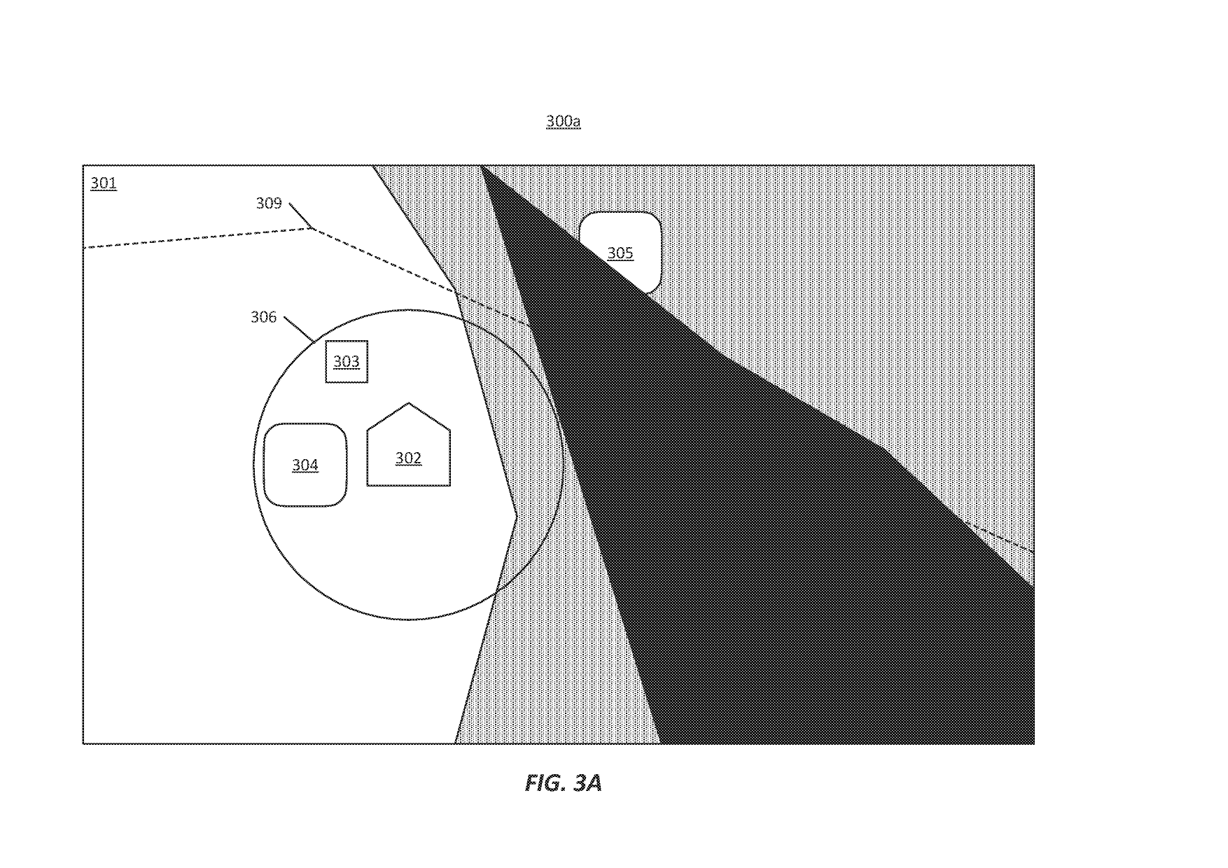

FIG. 2 illustrates an example 200 of the resource automation component 111 of FIG. 1. Each element of resource automation component 111 depicted in FIG. 2 represents various functionalities that resource automation component 111 may implement under the embodiments described herein. These components—including their identity and arrangement—are presented merely to describe example embodiments of resource automation component 111.

In FIG. 2, resource automation component 111 includes an automation engine 201 that considers various input factors to determine the tasks to be carried out by one or more economic development units. In embodiments, the automation engine 201 considers factors including, as examples, a virtual resource production goal, a reserve of the particular virtual resource type that has been previously gathered by the economic development units, the availability of virtual resource sources and their distance from a defined point (e.g., town center), the likelihood of peril to a virtual character in seeking out a virtual resource source (e.g., based on prior observation of enemies, foes, or wild animals), attributes (e.g., strengths and weaknesses) of a particular economic development unit, attributes (e.g., strengths and weaknesses) a virtual population of which the virtual character is a member (e.g., societal attributes), and the like. The form of the logic of resource automation component 111 can vary, but examples of logic include a set of rules, one or more decision trees, one or more artificial intelligence (AI) models, one or more machine learning (ML) models, and the like.

A unit management component 202 tracks and manages the individual status of a set of one or more virtual characters operating as economic development units. This includes, for example, managing a current virtual resource-gathering assignment (e.g., gather a food resource, gather a building resource, gather a precious metal resource), a current source of a virtual resource from which the virtual character gathers the resource (e.g., a mine, an ore deposit, a forested region of a virtual space), the virtual character’s health, and the like. Based on an analysis by automation engine 201, the unit management component 202 can update various statuses of virtual characters, such as giving them a new virtual resource-gathering assignment, directing them to a new virtual resource source, and the like.

A resource production component 203 manages an overall resource production goal for the set of one or more virtual characters operating as economic development units. In embodiments, an overall resource production goal specifies a relative allocation of a plurality of virtual resource types for the economic development units to gather. For example, if virtual resources comprise wood, food, stone, and gold, an overall resource production goal may specify that economic development unit resource gathering should target 30% wood, 30% food, 20% stone, and 20% gold. In embodiments, the overall resource production goal is user-specified, based on a preset, or based on a manual selection of a relative allocation of virtual resource types. In embodiments, the overall resource production goal can be altered over time. For example, early on in an RTS game session, the resource production goal may emphasize raw materials for building a village for producing more economic development units (e.g., an emphasis on wood and food). As the RTS game session progresses, the resource production goal may emphasize materials for improving structures and advancing a society (e.g., emphasizing stone and gold). Late in the RTS game session, the resource production goal may emphasize materials for waging war (e.g., food and gold). In some embodiments, the changing of a resource production goal is initiated by a player. In other embodiments, the changing of a resource production goal is initiated by unit management component 202.

An RTS game 109 can provide a variety of UIs for managing overall resource production goals. In some embodiments, a UI enables a player to manually manage an allocation of resources, including providing an ability to save the allocation as a preset. Some embodiments enable a player to name a preset, to set a trigger for when the preset automatically activates, and the like. Example triggers include a particular population being reached, a particular structure or set of structures being built, being attacked, attacking, etc. In additional or alternative embodiments, the UI provides a plurality of built-in presets (e.g., settlement, economic development, offense, defense, research) for different phases of an RTS. Some embodiments enable a player to save custom presets (e.g., to storage medium 104) and load those custom presets in a future RTS game session. Some embodiments enable players to exchange custom presets (e.g., via network 107). UIs may indicate the relative allocation of resources in various ways, such as using pie charts (e.g., where each resource is a different color), using percentages, etc.

In some embodiments, these presents are customized to particular attributes of the society being simulated for the player. In one example, the presets for one society emphasize gathering resources representing physical commodity types over mystical resources, while the presets for another emphasize gathering mystical resources over resources representing physical commodity types. In another example, the presets for one society emphasize gathering wood for construction, while the presets for another emphasize gathering stone for construction.

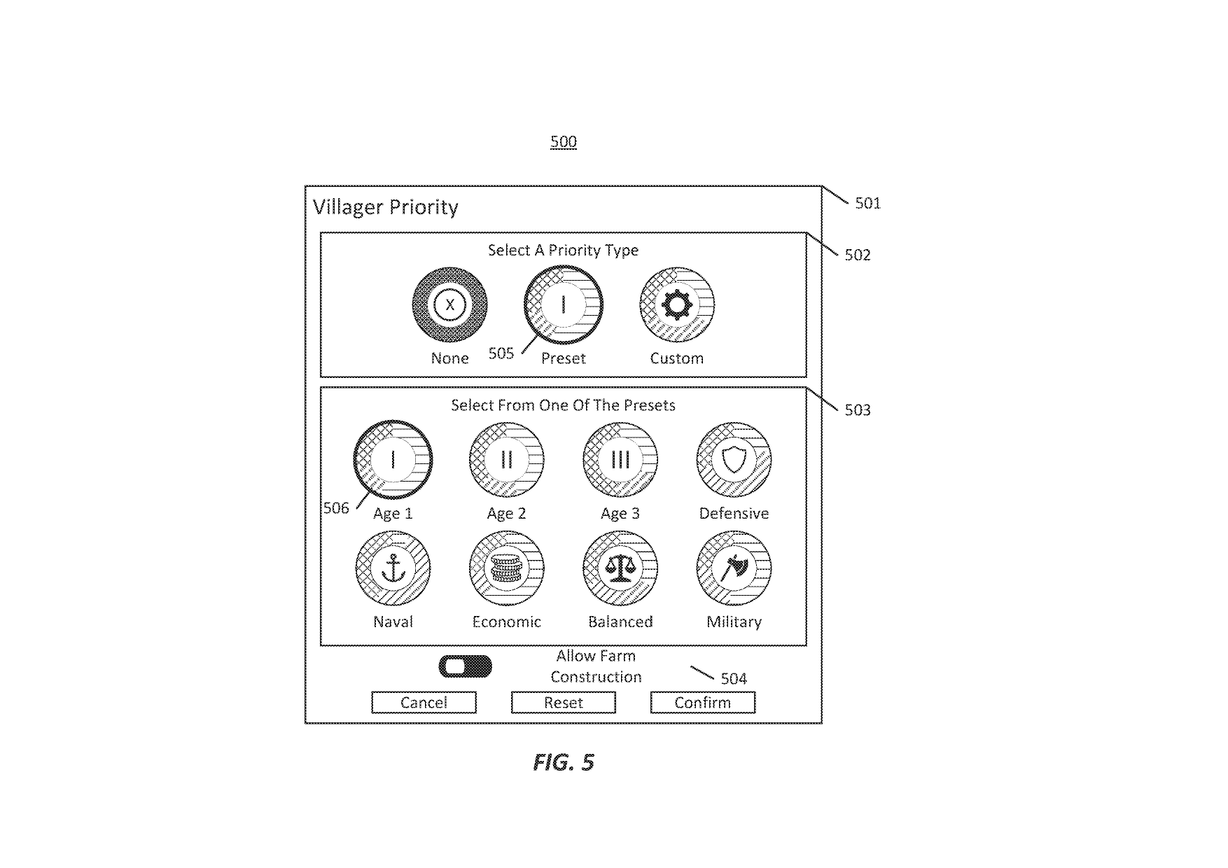

FIG. 5 illustrates one example 500 of a UI 501 that allows a player to set a resource production goal, though there are many UIs that could be used. UI 501 is a “villager priority” UI, enabling users to select a priority type (pane 502). In example 500, a user can select None, Preset 505, or Custom. In FIG. 5, a user has selected Preset 505. After a player has selected Preset 505 in pane 502, pane 503 provides a set of available presets, including “Age I” (present 506), “Age II,” “Age III,” “Defensive,” “Naval,” “Economic,” “Balanced,” and “Military.” In some examples, these presets are pre-defined by the RTS game. In other examples, a player defines or customizes one or more presets. In some embodiments, selecting Preset 505 in pane 502 presents RTS game-defined presets in pane 503, while selecting Custom in pane 502 presents user-defined presets in pane 503. Each preset includes an outer ring adorned with shadings/patterns that show the relative resource allocations for the present resource production goal in a pie chart form. In this example, there are three different virtual resources (e.g., wood, food, and stone), and the shadings/patterns show the relative allocations of those three virtual resources for each preset. In addition, UI 501 includes option 504 to allow or disallow villagers to construct farms (e.g., to further the goal of gathering food resources).

A gathering radius component 204 defines a “gathering radius” around a particular point in a virtual space where economic development units can operate. In embodiments, the gathering radius operates as a danger radius within the risk of peril to economic development units (e.g., by enemy units or by wild animals) is considered relatively low. In some examples, a gathering radius is defined as being a particular distance from a resource gathering point, virtual character spawning point, etc. Examples include a town center, a command center, a headquarters, or a fortress. Based on the analysis performed by the automation engine 201, the gathering radius component 204 expands, or even contracts, a gathering radius as an RTS game session progresses. In one example, as the availability of virtual resource sources within the gathering radius diminishes, the automation engine 201 may instruct the gathering radius component 204 to expand the gathering radius to include virtual resource sources in areas more perilous to economic development units. Another example, as the presence of enemies within a virtual space increases, the automation engine 201 may instruct the gathering radius component 204 to contract the gathering radius to avoid increased peril to economic development units.

In some embodiments, the logic of the automation engine 201 includes at least one trained AI or ML model. In these embodiments, the AI/ML model is trained based on training data comprising telemetry obtained from RTS game sessions carried out by human users. For example, training data may indicate when a player utilizes different resource production goal presets or custom resource allocations at various points in an RTS game session, how risk-averse a player is to sending resource production units into unexplored or enemy territory at various points in an RTS game session, and the like. In some embodiments, an AI/ML model is trained based on training data obtained from a plurality of users, such as a cohort of users of the RTS game who have opted-in to share telemetry data. In other embodiments, an AI/ML model is trained based on training data obtained from a single user, such that the AI/ML model is customized to that user’s past behaviors and preferences. In some embodiments, an AI/ML model is trained based on training data obtained from a plurality of users and then customized based on training data obtained from an individual user.

In embodiments, resource automation component 111 provides additional functionality to help with economic development unit management. In one embodiment, economic development unit management units automatically build structures that support their growth and resource gathering. For instance, villagers may automatically build houses to support their growing population and may automatically build farms to support the gathering of food resources. Other embodiments provide a site-based command feature in which a player selects a destination site of a virtual space, and resource automation component 111 automatically (based on automation engine 201) identifies an economic development unit to send to that site. For instance, the player selects a mine, and resource automation component 111 automatically selects a villager to task with harvesting from that mine.

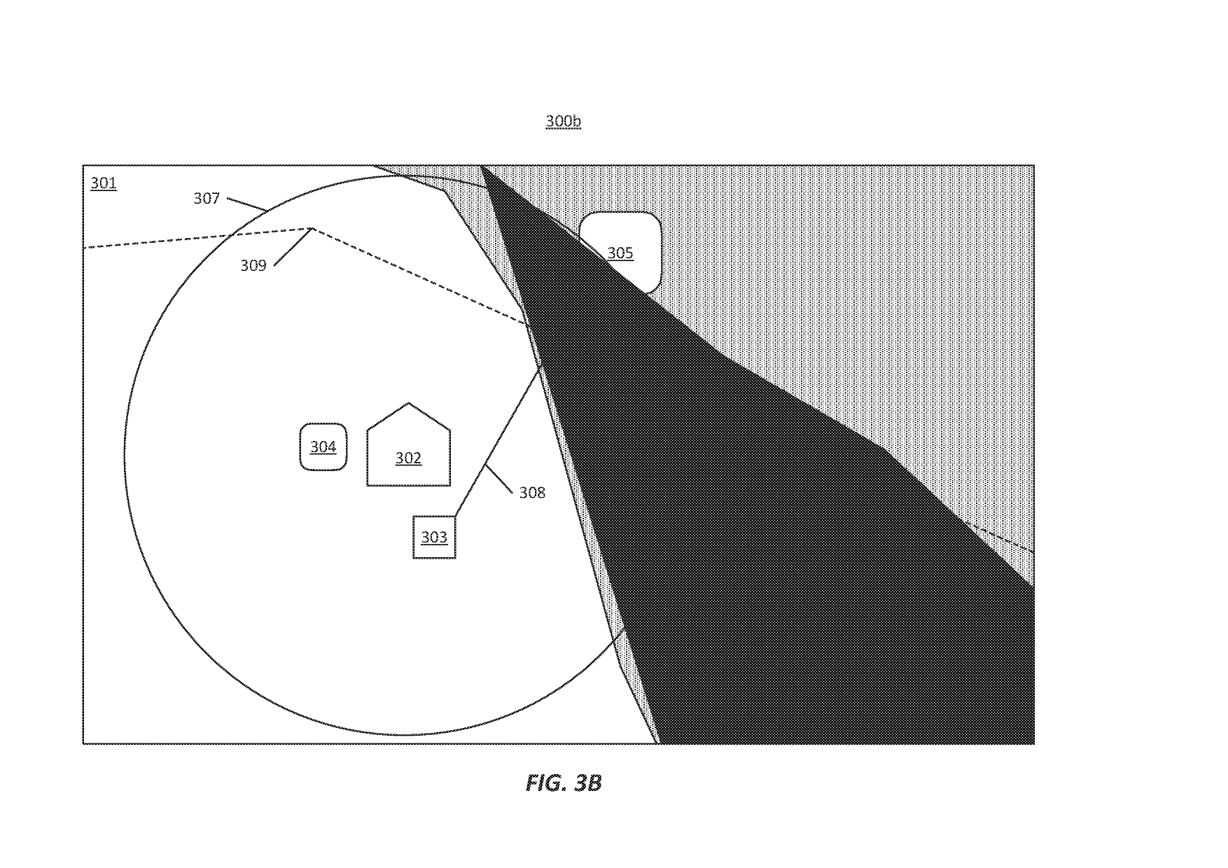

FIGS. 3A and 3B illustrate example 300 (including example 300a and example 300b) of the operation of the resource automation component 111 during an RTS game session. Turning to FIG. 3A, example 300a includes a virtual space 301, such as a portion of an RTS game map produced by RTS game 109. Virtual space 301 includes a gathering point 302, such as a town center, a command center, a headquarters, or a fortress. Example 300a shows a gathering radius 306 centered on gathering point 302, within which economic development units, such as a virtual character 303, operate to gather virtual resources according to a resource production goal. For example, virtual character 303 gathers virtual resources from a resource source 304 within the gathering radius 306. In example 300a, a black-filled region indicates a portion of the virtual space 301 that has not yet been explored (e.g., a region in which the “fog of war” has not yet been lifted), while a shaded region indicates a portion of the virtual space 301 that has been previously explored (and the “fog of war” been lifted) but for which there is no current line-of-sight by any of the player’s units. Thus, the player’s units have prior knowledge of the shaded region but no current knowledge of the shaded region. A dashed line 309 indicates a path that an enemy unit was known to have previously traversed.

Notably, virtual space 301 includes a resource source 305 that has been partially discovered by one of the player’s units previously, but there is no current knowledge (e.g., line-of-sight) of the area in which resource source 305 resides. Given, e.g., the immediate availability of resource source 304 within gathering radius 306, the lack of current knowledge of resource source 305, and the fact that an enemy unit previously traversed near resource source 305, automation engine 201 determines that it is not worth the risk of peril to the virtual character 303 to send the virtual character 303 to resource source 305. As such, the unit management component 202 maintains the current resource gathering assignment for the virtual character 303, and the gathering radius component 204 maintains the current size of the gathering radius 306. Other potential factors the automation engine 201 could consider include current resource reserves, particular attributes of virtual character 303 and/or the virtual character’s society, the length of progression of the RTS game session, and the like.

FIG. 3B illustrates an example 300b after further progression of the RTS game session. In example 300b, resource source 304 is visually smaller, indicating that it is nearly depleted. Given the imminent full depletion of resource source 304 within gathering radius 306, the potential availability of resource source 305, an expansion of line-of-sight near resource source 305, and the fact that no additional enemy units have been observed to have traversed near resource source 305 (potentially along with other factors), the automation engine 201 determines that it is now worth the risk of peril to the virtual character 303 to send the virtual character 303 to resource source 305. As such, the gathering radius component 204 expands the size of the gathering radius (gathering radius 307) to include a least a part of resource source 305, and the unit management component 202 updates the current resource gathering assignment for the virtual character 303 to gather resources from resource source 305. This includes assigning virtual character 303 to traverse path 308 to resource source 305, including the virtual character 303 traversing through the unexplored region of virtual space 301.

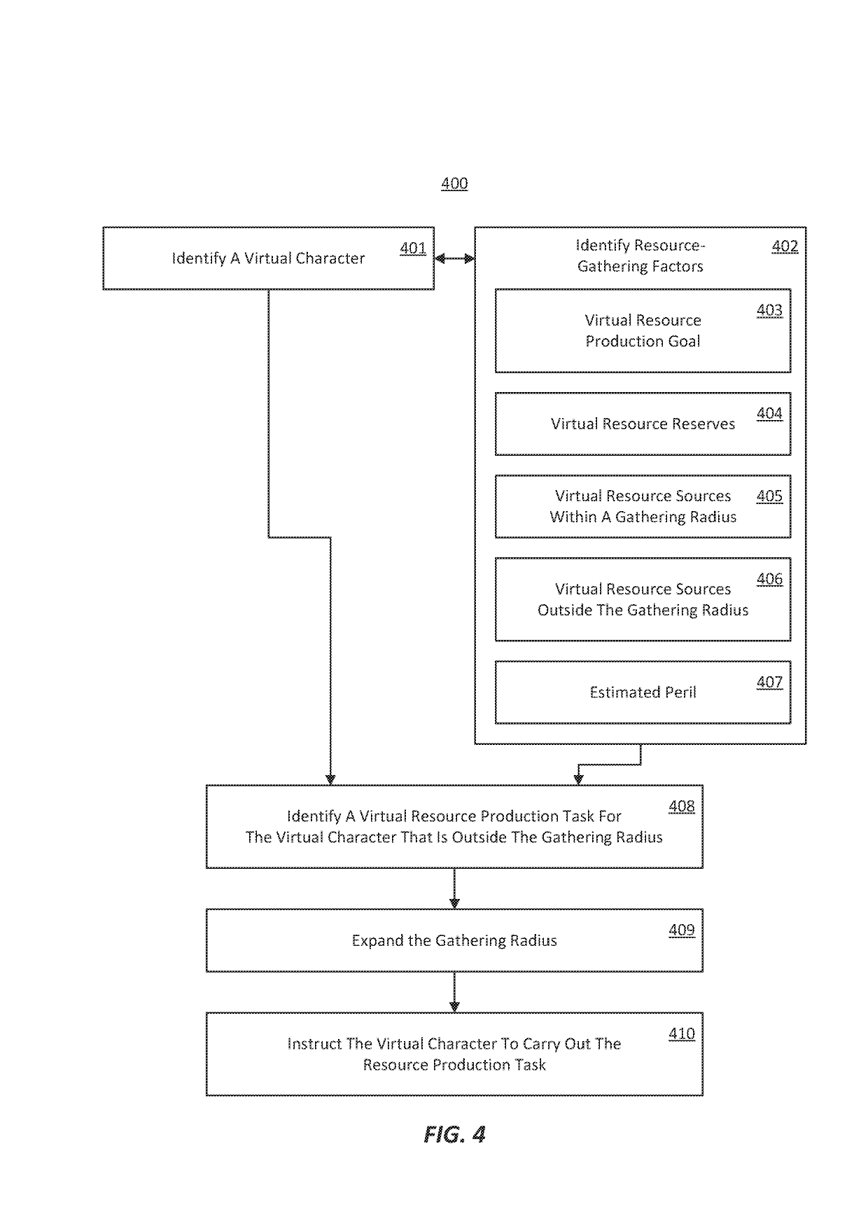

Embodiments are now described in connection with FIG. 4, which illustrates a flow chart of an example method 400 for automating digital resource production within an RTS. In embodiments, instructions for implementing method 400 are encoded as computer-executable instructions (e.g., game engine 110, virtual resource automation component 111) stored on a computer storage medium (e.g., storage medium 104) that are executable by a processor system (e.g., processor system 102) to cause a computer system (e.g., computer system 101) to perform method 400.

The following discussion now refers to a method and method acts. Although the method acts are discussed in specific orders or are illustrated in a flow chart as occurring in a particular order, no order is required unless expressly stated or required because act is dependent on another act being completed prior to the act being performed.

Referring to FIG. 4, in embodiments, method 400 comprises act 401 of identifying a virtual character. In some embodiments, act 401 identifies a virtual character residing at a first location in a virtual space that is within a defined distance from a second location in the virtual space, the virtual character capable of gathering a plurality of virtual resource types based on interfacing with virtual resource sources of a plurality of different types, each type of virtual resource source enabling the virtual character to produce a different type of virtual resource. For example, the automation engine 201 identifies virtual character 303 within virtual space 301. Virtual character 303 is an economic production unit that gathers virtual resources (e.g., wood, food, stone, gold) from a resource source (e.g., forest, farm, ore deposit, mine).

As mentioned, in embodiments, virtual characters are economic development units presented as digital representations of villagers, peasants, drones, workers, and the like. Thus, in embodiments, the virtual character is a virtual representation of a type of physical being. In embodiments, virtual resources may represent real-world resource analogs (e.g., food, wood, stone, gold, silver). Thus, in embodiments, at least one virtual resource type is a virtual representation of a physical commodity type. This may include one or more of a food source, a building material, or a currency material. In embodiments, virtual resources may represent mystical resources (e.g., favor, mana, essence, faith, wisdom). Thus, in embodiments, at least one virtual resource type is a virtual representation of a mystical resource.

Method 400 comprises act 402 of identifying resource-gathering factors. In some embodiments, act 401 identifies resource-gathering factors for the virtual character. For example, as mentioned, the automation engine 201 can consider resource-gathering factors such as a virtual resource production goal, a reserve of the particular virtual resource type that has been previously gathered by the economic development units, the availability of virtual resource sources and their distance from a defined point (e.g., town center), the likelihood of peril to a virtual character in seeking out a virtual resource source (e.g., based on prior observation of enemies, foes, or wild animals), attributes (e.g., strengths and weaknesses) of a particular economic development unit, attributes (e.g., strengths and weaknesses) a virtual population of which the virtual character is a member (e.g., societal attributes), and the like. Other factors, or alternative factors, may be possible.

Notably, no ordering is required between act 401 and act 402, and various embodiments may perform them serially (in either order) or in parallel.

As shown in act 402, in some embodiments identifying the resource-gathering factors includes act 403 of identifying a virtual resource production goal. In embodiments, act 403 identifies a virtual resource production goal, the virtual resource production goal specifying a relative allocation of each of the plurality of virtual resource types to be gathered by a set of virtual characters that includes the virtual character, the virtual resource production goal including a goal to gather an amount of a particular virtual resource type. For example, resource production component 203 manages an overall resource production goal for the set of one or more virtual characters operating as economic development units. For instance, if virtual resources comprise wood, food, stone, and gold, an overall resource production goal may specify that economic development unit resource gathering should target 30% wood, 30% food, 20% stone, and 20% gold.

Some embodiments enable players to customize, save, share, and load virtual resource production goal presets. For example, act 403 may include one or more of receiving a user input customizing the relative allocation of each of the plurality of virtual resource types to be gathered by the set of virtual characters, saving the relative allocation of each of the plurality of virtual resource types to be gathered by the set of virtual characters as a custom preset, or loading the relative allocation of each of the plurality of virtual resource types to be gathered by the set of virtual characters from a custom preset.

In act 402, in some embodiments identifying the resource-gathering factors also includes act 404 of identifying virtual resource reserves. In embodiments, act 404 identifies a reserve of the particular virtual resource type previously gathered by the set of virtual characters. For example, the automation engine 201 identifies the availability of resource sources, such as resource source 304 and resource source 305 in example 300.

In act 402, in some embodiments identifying the resource-gathering factors also includes act 405 of identifying virtual resource sources within a gathering radius. In embodiments, act 405 identifies the availability of a virtual resource source that provides the particular virtual resource type within the defined distance from the second location in the virtual space. For example, the automation engine 201 identifies the availability of resource source 304 within the gathering radius 306.

In act 402, in some embodiments identifying the resource-gathering factors also includes act 406 of identifying virtual resource sources outside the gathering radius. In embodiments, act 406 identifies a likelihood of an additional virtual resource source that provides the particular virtual resource type existing at a third location in the virtual space, the third location in the virtual space being beyond the defined distance from the second location in the virtual space. For example, the automation engine 201 identifies the availability of resource source 305 outside of gathering radius 306.

In act 402, in some embodiments identifying the resource-gathering factors also includes act 407 of identifying an estimated peril. In embodiments, act 403 identifies a likelihood of peril to the virtual character existing between the first location in the virtual space and the third location in the virtual space. For example, the automation engine 201 determines the likelihood of peril to the virtual character between gathering radius 306 and resource source 305. Factors may include whether or not an area the virtual character would traverse has been explored (e.g., whether or not the fog of war has been lifted), whether or not an area the virtual character would traverse has current knowledge (e.g., if the fog of war has been lifted, is there line of sight), how current knowledge is of an area the virtual character would traverse, known enemy activity an area the virtual character would traverse, etc. In embodiments, calculating the likelihood of peril to the virtual character that exists between the first location in the virtual space and the third location in the virtual space based on a prior exploration of at least a portion of a path between the first location in the virtual space and the third location in the virtual space.

While acts 403–407 provide some example factors, others are also possible. For example, in some embodiments of act 402, the set of resource-gathering factors also includes one or more attributes of a virtual population of which the virtual character is a member (e.g., strengths/weaknesses of the virtual character’s society), one or more attributes of the virtual character (e.g., strengths/weaknesses of the virtual character itself), a user-specified site point indicating the third location in the virtual space, and the like.

Method 400 comprises act 408 of identifying a virtual resource production task for the virtual character outside the gathering radius. In some embodiments, act 408 comprises, based on the set of resource-gathering factors, determining a virtual resource-gathering assignment for the virtual character that includes traversing from the first location in the virtual space to the third location in the virtual space. For example, in example 300b, automation engine 201 determined that resource need was worth the peril of assigning virtual character 303 to gather resources from resource source 305. Based on act 408, method 400 comprises act 409 of expanding the gathering radius. In some embodiments, act 409 comprises, based on resource-gathering factors, expanding the defined distance to include the third location in the virtual space. For example, gathering radius component 204 expands gathering radius 306 to gathering radius 307, which includes resource source 305.

In some examples, expanding the defined distance to include the third location in the virtual space is based on the reserve of the particular virtual resource type and the availability of the virtual resource source that provides the particular virtual resource type within the defined distance from the second location in the virtual space being insufficient to meet the goal to gather the amount of the particular virtual resource type. Additionally, or alternatively, in some examples, expanding the defined distance to include the third location in the virtual space is further based on the likelihood of the additional virtual resource source that provides the particular virtual resource type existing at the third location in the virtual space overweighing the likelihood of peril to the virtual character existing between the first location in the virtual space and the third location in the virtual space.

Method 400 comprises act 410 of instructing the virtual character to carry out the resource production task. In some embodiments, act 410 comprises, based on the set of resource-gathering factors, instructing the virtual character to traverse from the first location in the virtual space to the third location in the virtual space. For example, the unit management component 202 updates the resource gathering assignments for virtual character 303 to include gathering resources from resource source 305. Notably, in some embodiments, instructing the virtual character to traverse from the first location in the virtual space to the third location in the virtual space may include instructing the virtual character to traverse an unexplored region of the virtual space (e.g., as demonstrated in example 300b).

In embodiments, method 400 operates in a continual or periodic loop, controlling the resource-gathering tasks for various economic production units.

Alternatively or in addition to the other examples described herein, examples include any combination of the following:

Clause 1. A method implemented by an RTS game executing at a processor system of a computer system for automating digital resource production within the RTS, the method comprising: identifying a virtual character residing at a first location in a virtual space that is within a defined distance from a second location in the virtual space, the virtual character capable of gathering a plurality of virtual resource types based on interfacing with virtual resource sources of a plurality of different types, each type of virtual resource source enabling the virtual character to produce a different type of virtual resource; identifying a set of resource-gathering factors for the virtual character, the set of resource-gathering factors including at least: a virtual resource production goal, the virtual resource production goal specifying a relative allocation of each of the plurality of virtual resource types to be gathered by a set of virtual characters that includes the virtual character, the virtual resource production goal including a goal to gather an amount of a particular virtual resource type; a reserve of the particular virtual resource type that has been previously gathered by the set of virtual characters; an availability of a virtual resource source that provides the particular virtual resource type within the defined distance from the second location in the virtual space; a likelihood of an additional virtual resource source that provides the particular virtual resource type existing at a third location in the virtual space, the third location in the virtual space being beyond the defined distance from the second location in the virtual space; and a likelihood of peril to the virtual character existing between the first location in the virtual space and the third location in the virtual space; and based on the set of resource-gathering factors: expanding the defined distance to include the third location in the virtual space; determining a virtual resource-gathering assignment for the virtual character that includes traversing from the first location in the virtual space to the third location in the virtual space; and instructing the virtual character to traverse from the first location in the virtual space to the third location in the virtual space.

Clause 2. The method of clause 1, wherein expanding the defined distance to include the third location in the virtual space is based on the reserve of the particular virtual resource type and the availability of the virtual resource source that provides the particular virtual resource type within the defined distance from the second location in the virtual space being insufficient to meet the goal to gather the amount of the particular virtual resource type.

Clause 3. The method of any of clause 1 or claim 2, wherein expanding the defined distance to include the third location in the virtual space is further based on the likelihood of the additional virtual resource source that provides the particular virtual resource type existing at the third location in the virtual space overweighing the likelihood of peril to the virtual character existing between the first location in the virtual space and the third location in the virtual space.

Clause 4. The method of any of clause 1 to claim 3, wherein instructing the virtual character to traverse from the first location in the virtual space to the third location in the virtual space includes instructing the virtual character to traverse an unexplored region of the virtual space.

Clause 5. The method of any of clause 1 to claim 4, wherein the set of resource-gathering factors also includes one or more attributes of a virtual population of which the virtual character is a member.

Clause 6. The method of any of clause 1 to claim 5, wherein the set of resource-gathering factors also includes one or more attributes of the virtual character.

Clause 7. The method of any of clause 1 to claim 6, wherein the virtual character is a virtual representation of a type of physical being.

Clause 8. The method of any of clause 1 to claim 7, wherein at least one virtual resource type is a virtual representation of a physical commodity type.

Clause 9. The method of any of clause 1 to claim 8, wherein the plurality of virtual resource types are virtual representations of one or more of a food source, a building material, or a currency material.

Clause 10. The method of any of clause 1 to claim 9, wherein at least one virtual resource type is a virtual representation of a mystical resource.

Clause 11. The method of any of clause 1 to claim 10, wherein the method further comprises: receiving a user input customizing the relative allocation of each of the plurality of virtual resource types to be gathered by the set of virtual characters.

Clause 12. The method of clause 11, wherein the method further comprises: saving the relative allocation of each of the plurality of virtual resource types to be gathered by the set of virtual characters as a custom preset.

Clause 13. The method of clause 11, wherein the method further comprises: loading the relative allocation of each of the plurality of virtual resource types to be gathered by the set of virtual characters from a custom preset.

Clause 14. The method of any of clause 1 to claim 13, wherein the set of resource-gathering factors also includes a user-specified sight point indicating the third location in the virtual space.

Clause 15. The method of any of clause 1 to claim 14, wherein the method further comprises: calculating the likelihood of peril to the virtual character that exists between the first location in the virtual space and the third location in the virtual space based on a prior exploration of at least a portion of a path between the first location in the virtual space and the third location in the virtual space.

Clause 16. A computer system, comprising: a processor system; and a computer storage medium that stores computer-executable instructions that are executable by the processor system to automate digital resource production within an RTS, the computer-executable instructions executable by the processor system to at least: identify a virtual character residing at a first location in a virtual space that is within a defined distance from a second location in the virtual space, the virtual character capable of gathering a plurality of virtual resource types based on interfacing with virtual resource sources of a plurality of different types, each type of virtual resource source enabling the virtual character to produce a different type of virtual resource; identify a set of resource-gathering factors for the virtual character, the set of resource-gathering factors including at least: a virtual resource production goal, the virtual resource production goal specifying a relative allocation of each of the plurality of virtual resource types to be gathered by a set of virtual characters that includes the virtual character, the virtual resource production goal including a goal to gather an amount of a particular virtual resource type; a reserve of the particular virtual resource type that has been previously gathered by the set of virtual characters; an availability of a virtual resource source that provides the particular virtual resource type within the defined distance from the second location in the virtual space; a likelihood of an additional virtual resource source that provides the particular virtual resource type existing at a third location in the virtual space, the third location in the virtual space being beyond the defined distance from the second location in the virtual space; and a likelihood of peril to the virtual character existing between the first location in the virtual space and the third location in the virtual space; and based on the set of resource-gathering factors: expand the defined distance to include the third location in the virtual space; determine a virtual resource-gathering assignment for the virtual character that includes traversing from the first location in the virtual space to the third location in the virtual space; and instruct the virtual character to traverse from the first location in the virtual space to the third location in the virtual space.

Clause 17. The computer system of clause 16, wherein expanding the defined distance to include the third location in the virtual space is based on, the reserve of the particular virtual resource type and the availability of the virtual resource source that provides the particular virtual resource type within the defined distance from the second location in the virtual space being insufficient to meet the goal to gather the amount of the particular virtual resource type; and the likelihood of the additional virtual resource source that provides the particular virtual resource type existing at the third location in the virtual space overweighing the likelihood of peril to the virtual character existing between the first location in the virtual space and the third location in the virtual space.

Clause 18. The computer system of any of clause 16 to claim 17, wherein the set of resource-gathering factors also includes: one or more first attributes of a virtual population of which the virtual character is a member; and one or more second attributes of the virtual character.

Clause 19. The computer system of any of clause 16 to claim 18, wherein the computer-executable instructions are also executable by the processor system to at least: receive a user input customizing the relative allocation of each of the plurality of virtual resource types to be gathered by the set of virtual characters; and save the relative allocation of each of the plurality of virtual resource types to be gathered by the set of virtual characters as a custom preset.

Clause 20. A computer storage medium that stores computer-executable instructions that are executable by a processor system to automate digital resource production within an RTS, the computer-executable instructions including instructions that are executable by the processor system to at least: identify a virtual character residing at a first location in a virtual space that is within a defined distance from a second location in the virtual space, the virtual character capable of gathering a plurality of virtual resource types based on interfacing with virtual resource sources of a plurality of different types, each type of virtual resource source enabling the virtual character to produce a different type of virtual resource; identify a set of resource-gathering factors for the virtual character, the set of resource-gathering factors including at least: a virtual resource production goal, the virtual resource production goal specifying a relative allocation of each of the plurality of virtual resource types to be gathered by a set of virtual characters that includes the virtual character, the virtual resource production goal including a goal to gather an amount of a particular virtual resource type; a reserve of the particular virtual resource type that has been previously gathered by the set of virtual characters; an availability of a virtual resource source that provides the particular virtual resource type within the defined distance from the second location in the virtual space; a likelihood of an additional virtual resource source that provides the particular virtual resource type existing at a third location in the virtual space, the third location in the virtual space being beyond the defined distance from the second location in the virtual space; and a likelihood of peril to the virtual character existing between the first location in the virtual space and the third location in the virtual space; and based on the set of resource-gathering factors: expand the defined distance to include the third location in the virtual space; determine a virtual resource-gathering assignment for the virtual character that includes traversing from the first location in the virtual space to the third location in the virtual space; and instruct the virtual character to traverse from the first location in the virtual space to the third location in the virtual space.

Embodiments of the disclosure comprise or utilize a special-purpose or general-purpose computer system (e.g., computer system 101) that includes computer hardware, such as, for example, a processor system (e.g., processor system 102) and system memory (e.g., memory 103), as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media (e.g., storage medium 104). Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 105) and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more central processing units (CPUs), one or more graphics processing units (GPUs), one or more neural processing units (NPUs), and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (SaaS), Platform as a Service (PaaS), Infrastructure as a Service (IaaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more virtual machines (VMs). During operation, VMs emulate an operational computing system, supporting an operating system (OS) and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method implemented by a real-time strategy game (RTS) executing at a processor system of a computer system for automating digital resource production within the RTS, the method comprising:
identifying a virtual character residing at a first location in a virtual space that is within a defined distance from a second location in the virtual space, the virtual character capable of gathering a plurality of virtual resource types based on interfacing with virtual resource sources of a plurality of different types, each type of virtual resource source enabling the virtual character to produce a different type of virtual resource;
identifying a set of resource-gathering factors for the virtual character, the set of resource-gathering factors including at least:
a virtual resource production goal, the virtual resource production goal specifying a relative allocation of each of the plurality of virtual resource types to be gathered by a set of virtual characters that includes the virtual character, the virtual resource production goal including a goal to gather an amount of a particular virtual resource type;
a reserve of the particular virtual resource type that has been previously gathered by the set of virtual characters;
an availability of a virtual resource source that provides the particular virtual resource type within the defined distance from the second location in the virtual space;
a likelihood of an additional virtual resource source that provides the particular virtual resource type existing at a third location in the virtual space, the third location in the virtual space being beyond the defined distance from the second location in the virtual space; and
a likelihood of peril to the virtual character existing between the first location in the virtual space and the third location in the virtual space; and
based on the set of resource-gathering factors:
expanding the defined distance to include the third location in the virtual space;
determining a virtual resource-gathering assignment for the virtual character that includes traversing from the first location in the virtual space to the third location in the virtual space; and
instructing the virtual character to traverse from the first location in the virtual space to the third location in the virtual space.

2. The method of claim 1, wherein expanding the defined distance to include the third location in the virtual space is based on the reserve of the particular virtual resource type and the availability of the virtual resource source that provides the particular virtual resource type within the defined distance from the second location in the virtual space being insufficient to meet the goal to gather the amount of the particular virtual resource type.

3. The method of claim 1, wherein expanding the defined distance to include the third location in the virtual space is further based on the likelihood of the additional virtual resource source that provides the particular virtual resource type existing at the third location in the virtual space overweighing the likelihood of peril to the virtual character existing between the first location in the virtual space and the third location in the virtual space.

4. The method of claim 1, wherein instructing the virtual character to traverse from the first location in the virtual space to the third location in the virtual space includes instructing the virtual character to traverse an unexplored region of the virtual space.

5. The method of claim 1, wherein the set of resource-gathering factors also includes one or more attributes of a virtual population of which the virtual character is a member.

6. The method of claim 1, wherein the set of resource-gathering factors also includes one or more attributes of the virtual character.

7. The method of claim 1, wherein the virtual character is a virtual representation of a type of physical being.

8. The method of claim 1, wherein at least one virtual resource type is a virtual representation of a physical commodity type.

9. The method of claim 1, wherein the plurality of virtual resource types are virtual representations of one or more of a food source, a building material, or a currency material.

10. The method of claim 1, wherein at least one virtual resource type is a virtual representation of a mystical resource.

11. The method of claim 1, wherein the method further comprises:
receiving a user input customizing the relative allocation of each of the plurality of virtual resource types to be gathered by the set of virtual characters.

12. The method of claim 11, wherein the method further comprises:
saving the relative allocation of each of the plurality of virtual resource types to be gathered by the set of virtual characters as a custom preset.

13. The method of claim 11, wherein the method further comprises:
loading the relative allocation of each of the plurality of virtual resource types to be gathered by the set of virtual characters from a custom preset.

14. The method of claim 1, wherein the set of resource-gathering factors also includes a user-specified sight point indicating the third location in the virtual space.

15. The method of claim 1, wherein the method further comprises:
calculating the likelihood of peril to the virtual character that exists between the first location in the virtual space and the third location in the virtual space based on a prior exploration of at least a portion of a path between the first location in the virtual space and the third location in the virtual space.

16. A computer system, comprising:
a processor system; and
a computer storage medium that stores computer-executable instructions that are executable by the processor system to automate digital resource production within a real-time strategy game, the computer-executable instructions executable by the processor system to at least:
identify a virtual character residing at a first location in a virtual space that is within a defined distance from a second location in the virtual space, the virtual character capable of gathering a plurality of virtual resource types based on interfacing with virtual resource sources of a plurality of different types, each type of virtual resource source enabling the virtual character to produce a different type of virtual resource;
identify a set of resource-gathering factors for the virtual character, the set of resource-gathering factors including at least:
a virtual resource production goal, the virtual resource production goal specifying a relative allocation of each of the plurality of virtual resource types to be gathered by a set of virtual characters that includes the virtual character, the virtual resource production goal including a goal to gather an amount of a particular virtual resource type;
a reserve of the particular virtual resource type that has been previously gathered by the set of virtual characters;
an availability of a virtual resource source that provides the particular virtual resource type within the defined distance from the second location in the virtual space;
a likelihood of an additional virtual resource source that provides the particular virtual resource type existing at a third location in the virtual space, the third location in the virtual space being beyond the defined distance from the second location in the virtual space; and
a likelihood of peril to the virtual character existing between the first location in the virtual space and the third location in the virtual space; and
based on the set of resource-gathering factors:
expand the defined distance to include the third location in the virtual space;
determine a virtual resource-gathering assignment for the virtual character that includes traversing from the first location in the virtual space to the third location in the virtual space; and
instruct the virtual character to traverse from the first location in the virtual space to the third location in the virtual space.

17. The computer system of claim 16, wherein expanding the defined distance to include the third location in the virtual space is based on,
the reserve of the particular virtual resource type and the availability of the virtual resource source that provides the particular virtual resource type within the defined distance from the second location in the virtual space being insufficient to meet the goal to gather the amount of the particular virtual resource type; and
the likelihood of the additional virtual resource source that provides the particular virtual resource type existing at the third location in the virtual space overweighing the likelihood of peril to the virtual character existing between the first location in the virtual space and the third location in the virtual space.

18. The computer system of claim 16, wherein the set of resource-gathering factors also includes:
one or more first attributes of a virtual population of which the virtual character is a member; and
one or more second attributes of the virtual character.

19. The computer system of claim 16, wherein the computer-executable instructions are also executable by the processor system to at least:
receive a user input customizing the relative allocation of each of the plurality of virtual resource types to be gathered by the set of virtual characters; and
save the relative allocation of each of the plurality of virtual resource types to be gathered by the set of virtual characters as a custom preset.

20. A computer storage medium that stores computer-executable instructions that are executable by a processor system to automate digital resource production within a real-time strategy game, the computer-executable instructions including instructions that are executable by the processor system to at least:
identify a virtual character residing at a first location in a virtual space that is within a defined distance from a second location in the virtual space, the virtual character capable of gathering a plurality of virtual resource types based on interfacing with virtual resource sources of a plurality of different types, each type of virtual resource source enabling the virtual character to produce a different type of virtual resource;
identify a set of resource-gathering factors for the virtual character, the set of resource-gathering factors including at least:
a virtual resource production goal, the virtual resource production goal specifying a relative allocation of each of the plurality of virtual resource types to be gathered by a set of virtual characters that includes the virtual character, the virtual resource production goal including a goal to gather an amount of a particular virtual resource type;
a reserve of the particular virtual resource type that has been previously gathered by the set of virtual characters;
an availability of a virtual resource source that provides the particular virtual resource type within the defined distance from the second location in the virtual space;
a likelihood of an additional virtual resource source that provides the particular virtual resource type existing at a third location in the virtual space, the third location in the virtual space being beyond the defined distance from the second location in the virtual space; and
a likelihood of peril to the virtual character existing between the first location in the virtual space and the third location in the virtual space; and
based on the set of resource-gathering factors:
expand the defined distance to include the third location in the virtual space;
determine a virtual resource-gathering assignment for the virtual character that includes traversing from the first location in the virtual space to the third location in the virtual space; and
instruct the virtual character to traverse from the first location in the virtual space to the third location in the virtual space.
